(19) United States
(12) Patent Application Publication
(10) Pub. No.: US 2023/0087623 A1
(43) Pub. Date: Mar. 23, 2023

(54) CONTACT INFORMATION UPDATED BY DATA ANALYSIS

(71) Applicant: International Business Machines Corporation, Armonk, NY (US)

(72) Inventors: Fang Lu, Billerica, MA (US); Clement Decrop, Arlington, VA (US); Jeremy R. Fox, Georgetown, TX (US); Uri Kartoun, Cambridge, MA (US)

(21) Appl. No.: 17/448,532

(22) Filed: Sep. 23, 2021

(51) Int. Cl. G06Q 30/02; G06N 20/00

(52) U.S. Cl. CPC G06Q 30/0201; G06N 20/00; G06Q 30/0205; G16Y 10/75

(57) ABSTRACT

Correspondence information recorded by trusted entities is maintained up to date by monitoring user activity for location-based transaction data and determining by a machine learning algorithm when a piece of correspondence information has changed. When a change is detected, effected entities receive proposals for alternative temporary correspondence and formal change requests are submitted.

### BACKGROUND

The present invention relates generally to the field of data processing, and more particularly to user-based data collection and analysis.

Machine learning involves computer algorithms that can improve automatically through experience and by the use of collected data. Machine learning algorithms build a model based on sample data, referred to as “training data,” to make predictions or decisions without being explicitly programmed to do so.

In machine learning, a common task is the study and construction of algorithms that can learn from and make predictions based on received data. The algorithms function by building a mathematical model from training data and applying the learning to newly received data to make predictions founded in learned patterns, etc.

Personal information is information about an individual whose identity is apparent from the information. The term contact information as used herein describes certain information for contacting or corresponding with a user including: (i) home phone, (ii′ cell phone, (iii) mailing address, (iv) billing address, and (v) email address.

### SUMMARY

In one aspect of the present invention, a method, a computer program product, and a system includes: (i) identifying a set of contact information recorded at least in part by a set of trusted entities; (ii) monitoring, by a machine learning algorithm, user activity for location-based transaction data; (iii) detecting a change in a first piece of contact information of the set of contact information; (iv) responsive to detecting the change, identifying a sub-set of trusted entities using the first piece of contact information; and (v) submitting a change request to the sub-set of trusted entities.

In another aspect of the present invention, a method, a computer program product, and a system includes the step of, responsive to identifying the sub-set of trusted entities, proposing to the sub-set of trusted entities an alternative communication channel to the first piece of contact information. The sub-set of trusted entities use the first piece of contact information as a primary communication channel.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a schematic view of a second embodiment of a system according to the present invention.

### DETAILED DESCRIPTION

Correspondence information recorded by trusted entities is maintained up to date by monitoring user activity for location-based transaction data and determining by a machine learning algorithm when a piece of correspondence information has changed. When a change is detected, effected entities receive proposals for alternative temporary correspondence and formal change requests are submitted.

According to some embodiments of the present invention, a machine learning mechanism is supervised, i.e., a supervised learning algorithm, such as logistic regression or a neural network. Further, according to some embodiments of the present invention, the machine leaning mechanism is trained on an observational database. The observational database may contain a variety of details for users (i.e., customers) of an organization (e.g., a retail store chain) who routinely make purchases in stores managed by the organization. Each user in the database is associated with an array of characteristics and their associated values. Additionally, users who were identified as ones who changed their addresses in the past may be recognized, along with the date(s) of the movement(s).

The machine leaning model is being trained on the observational database containing features of all users relative to their movement on one or more dates, including “positive” users (those who moved to a different address) and “negative” users (those who are not known to be moving to one or more addresses). By providing the machine leaning model a data frame that contains details of positive and negative users along with their features, the model generates a data structure. The data structure can be used to calculate a movement likelihood score given any array of user features in a future time. The movement likelihood score may be calculated in real-time and may vary from one moment to another (e.g., a movement score may be 0.3 on January 3 and may be 0.6 on June 7 the following year, given different user characteristics provided to the machine learning model).

According to some embodiments of the present invention, the movement likelihood score for the user is a probability value. For example, a probability value may fall into the range of 0.0 (not likely to move within the next 3 months) to 1.0 (very likely to move within the next 3 months) or the probability value may be a numerical score in any range such as from 1 to 10. The score then could be used relative to a threshold to classify if a certain user is likely to be moving or has already moved. As an example, a threshold value may be configured as 0.5 where if the movement likelihood is higher than the threshold value then the user is likely to be move.

The present invention may be a system, a method, and/or a computer program product. The computer program product may include a computer readable storage medium (or media) having computer readable program instructions thereon for causing a processor to carry out aspects of the present invention.

Any data obtained for performing aspects of the present disclosure is obtained in good faith from users who both own the data and authorize the use of the data. A registration process for opting in to use of collected data for establishing potential physical address changes, phone number changes, email address changes, and/or other information that is monitored and updated according to embodiments of the present invention. The objective, when using collected data is to respect privacy concerns and associated rules established by corporate policy or government oversight. User approval for use of collected data and reporting of potential changes as well as updating contact/correspondence information is a necessary part of responsible practice of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

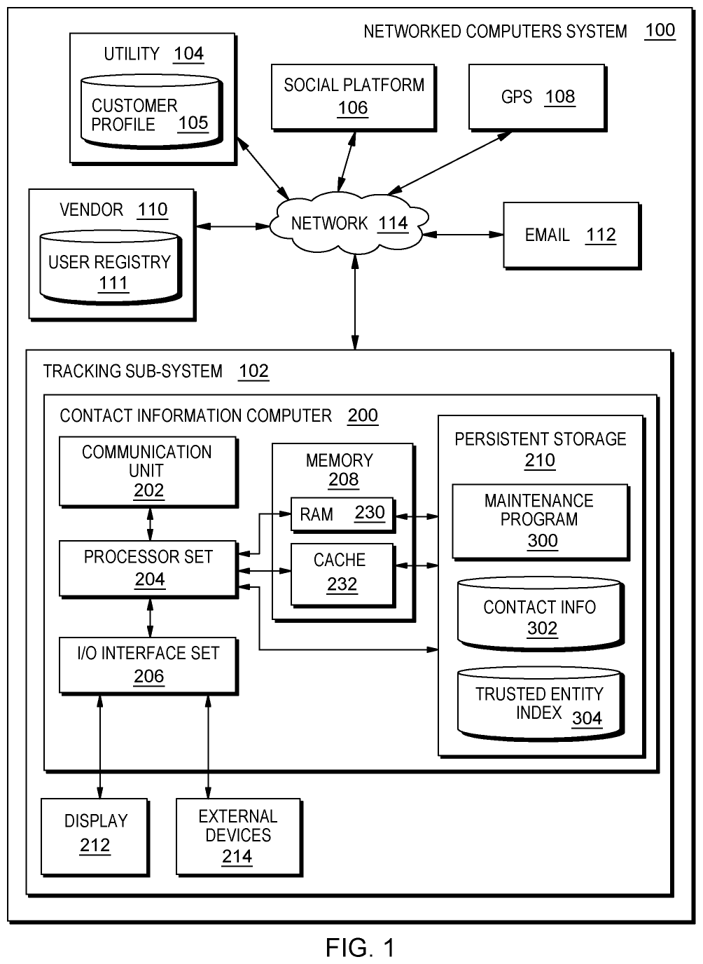

The present invention will now be described in detail with reference to the Figures. FIG. 1 is a functional block diagram illustrating various portions of networked computers system 100, in accordance with one embodiment of the present invention, including: tracking sub-system 102; utility sub-system 104; customer profile 105; social media platform sub-system 106; global positioning sub-system (GPS) 108; vendor sub-system 110; user registry 111; email sub-system 112; communication network 114; contact information computer 200; communication unit 202; processor set 204; input/output (I/O) interface set 206; memory device 208; persistent storage device 210; display device 212; external device set 214; random access memory (RAM) devices 230; cache memory device 232; address maintenance program 300; and contact information store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Address maintenance program 300 operates to detect and manage updates to user contact information for various entities with whom the user interacts and shares contact information. Monitoring transaction activity and training a statistical model to identify changes in contact information supports maintenance of contact information and communication of changes to interested trusted entities. According to some embodiments of the present invention, the maintenance program interacts with the user to assure communication of contact information changes are completed and accurate.

Some embodiments of the present invention recognize the following facts, potential problems and/or potential areas for improvement with respect to the current state of the art: (i) sometimes a user just needs to work in another location for short period of time and a change of contact information is not warranted; (ii) users may often change their mailing and/or billing addresses, particularly when they move from one residence to another; (iii) oftentimes contact information should be changed with certain vendors and/or service providers but the changes are not made for various reasons; (iv) when contact information is changed; it is often changed manually and the change is initiated by the user; (v) address verification systems (AVS) may require certain details that are not available for a particular vendor or service provider; and/or (vi) when an incorrect address is used or incomplete address fails the verification process, payments may not be completed, late fees my accrue, and additional fees may be incorrectly computed.

Some embodiments of the present invention develop a user-specific corpus while tracking user devices and corresponding locations. The corpus may be used for both training statistical models and for ongoing updates to statistical models developed through machine learning techniques.

Some embodiments of the present invention collect data from various Internet of Things (IoT) devices registered by the user. Data that may be collected includes: (i) IP addresses that reflects the locations that a user logs onto a specific application; (ii) location information of registered smart phones and/or smart watches; (iii) transaction data for various authorized applications for analyzing in-app purchases; (iv) social media username/address; (v) purchase method; and/or (vi) time of day.

Some embodiments of the present invention are directed to providing a learning period for training a statistical model using the developing user-specific corpus so that specific location trends can be recognized and considered when tracking future collected information. Further, there may be two aspects of the learning period including the time of day and the week/month/year timeline in which activity takes place. Time of day prediction relies upon identified patterns within the user-specific corpus and the basic notion that users are often at their residence during specific times of the day and perform other outside activities are specific times of the day. The learning period will vary by user and may be input by the user to assure that sufficient learning time has occurred before implemented any automated features for updated residential address and other contact information.

Some embodiments of the present invention derive a radius of convergence where a registered user makes in-person purchases. Where a significant number of purchases are made within a particular radius, that radius may be designated as a primary location of the user. During operation of embodiments of the present invention, a detected change in the derived radius of convergence supports a determination that a change of contact information may be necessary. For example, when a difference in radius of convergence is detected over a specified period of time and the current address is not within a pre-defined distance of the center of the radius of convergence, the user is prompted to change the address or to confirm that a change has taken place.

Some embodiments of the present invention are directed to a user-driven feedback loop for refining the statistical model. When a user rejects a proposed change of address, the response is used to redefine thresholds such as the size of the radius of convergence and the triggering timeline events.

Some embodiments of the present invention are directed to determining user contact information and changes to the contact information by collecting social network data, email, user-specific calendar data, and mapping program interactions. User contact information may be monitored using natural language processing (NLP) to gain insight into where a user will be moving or where the user will be travelling.

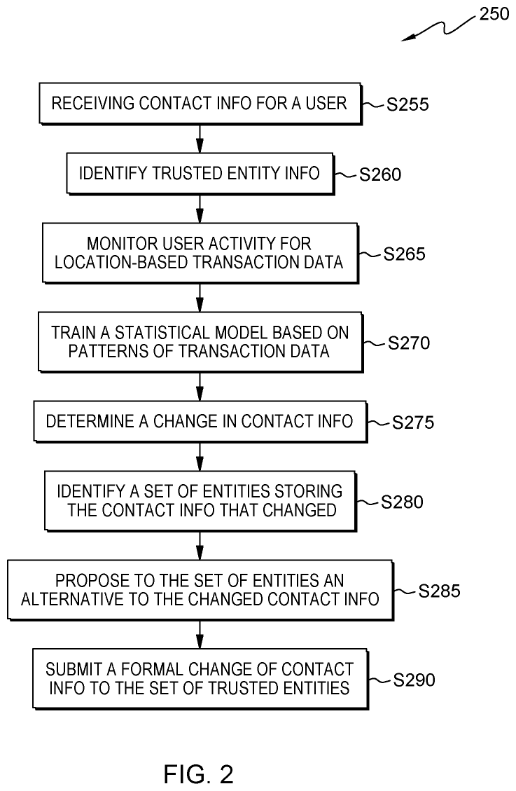

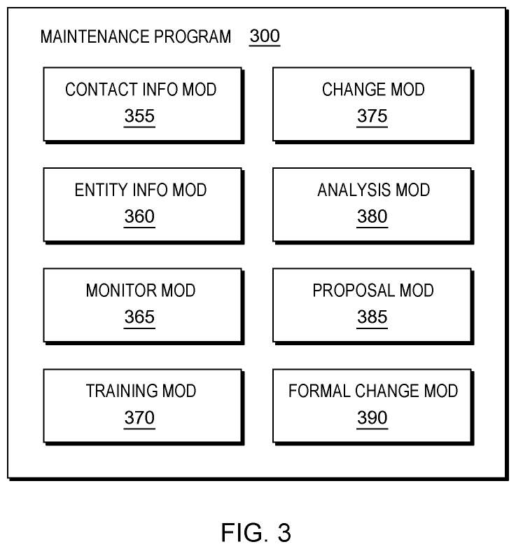

FIG. 2 shows flowchart 250 depicting a first method according to the present invention. FIG. 3 shows address maintenance program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where contact module (“mod”) 355 receives contact information for a user. Throughout this disclosure, the term contact information or correspondence information has been referred to as a physical address such as a mailing address. Other examples of contact/correspondence information may include: (i) phone number; (ii) social media username/address; (iii) billing address; (iv) email address; (v) preferred purchase method; and/or (vi) age of user. In this example, a user registers for a contact maintenance service that operates according to an embodiment of the present invention. The user may provide contact information directly at the time of registration. Alternatively, the maintenance program determines contact information from observed transactions with vendors and service providers and collected location information.

Processing proceeds to step S260, where entity mod 360 identifies trusted entity information. The term trusted entities as used herein refers to vendors, suppliers, or service providers with whom the user does business or otherwise has regular contact with such as internet service provider, cable company, medical professionals, restaurants, lawn care companies, online or brick and mortar retailers, and so forth. Each trusted entity records certain contact information of the user oftentimes including at least a mailing address or physical residence address. The contact information that a trusted entity records is identified as trusted entity information as stored for reference when taking measures to maintain up to date contact information of the user. In this example, contact information recorded by trusted entities is stored in contact information store 302 and a cross-reference is made to each entity and corresponding contact information in trusted entity index 304 (FIG. 1).

According to some embodiments of the present invention, trusted entity information is collected directly from entity records. For example, address maintenance program 300 may access customer profile database 105 within utility sub-system 104 (FIG. 1) to identify the contact information shared with the utility company.

Processing proceeds to step S265, where monitor mod 365 monitors user activity for location-based transaction data. In this example, user activity is monitored to identify for information useful in determining a change in contact information. User activity may include online transactions, social media posts, calendar entries, email data (such as receipts and order confirmations), and subscription activity. User activity may additionally reveal trusted entities that should be added to the trusted entity index along with corresponding contact information recorded by the entity. Location-based transaction data may include: (i) ship-to address; (ii) purchase location; (iii) IP address from which a transaction is made; (iv) time of day; and/or (v) online application used for purchase.

Processing proceeds to step S270, where training mod 370 trains a statistical model based on patterns found within the location-based transaction data collected in step S265. In this example, the statistical model is generated by machine learning processing using the collected location-based transaction data, identified trusted entity information; and received contact information of the user. In some examples, patterns are identified during preparation of a training dataset and may include identification of a radius of convergence where a registered user makes in-person purchases.

Processing proceeds to step S275, where change mod 375 determines a change in contact information. After generation of the trained statistical model, continued monitoring of user activity for location-based transaction data may indicate a change in certain contact information according to analysis performed by the trained model. When a potential change in contact information is determined, actions are taken to confirm the change of contact information and to make the necessary changes with the various trusted entities relying upon the particular contact information in question. In this example, the user is contacted to confirm the potential change as an actual change. In some embodiments, the response by the user as to whether or not an actual change has been made is provided as feedback to the statistical model for refinement. Alternatively, continued monitoring occurs for a pre-defined period of time to further evaluate the potential change. For example, a temporary change in contact information is made and further monitoring operates to confirm or dismiss the potential change.

In whatever way is approached to confirm the potential contact change, when the change to a piece of contact information is confirmed, the maintenance system automatically proceeds to update the contact information accordingly.

Processing proceeds to step S280, where analysis mod 380 identifies a set of trusted entities storing, or relying on, the piece of contact information that has changed. Not all trusted entities are relying upon each piece of contact information to be current. In this example, trusted entity index 304 contains which contact information is recorded by which entities. When a piece of contact information has changed, the system identifies which trusted entities should receive the updated contact information. Alternatively, each trusted entity is accessed by the system to determine if the piece of contact information is recorded or relied upon. For example, analysis mod 380 may access user registry 111 of vendor sub-system 110 (FIG. 1) to determine if a piece of contact information such as the user email address is recorded and/or flagged as relied upon by the vendor sub-system. For those trusted entities that rely upon the piece of contact information being up to date, the analysis mod identifies them.

Processing proceeds to step S285, where proposal mod 385 proposes to the identified set of trusted entities an alternative to the changed contact information. For example, if the email address is relied upon as a primary communication channel by the set of trusted entities, the proposal mod would notify the trusted entities that an alternative primary communication channel should be text messaging or paper mail instead of the email address. The proposal phase as described in step S285 supports uninterrupted communication with the user while the piece of contact information is revised. According to some embodiments of the present invention, the contact information is prioritized according to preferred contact channel or otherwise assigned a first contact channel, second contact channel, and so forth. In the case where ordered communication channels are established, the proposal module proposes alternative communication channels only to those trusted entities whose primary communication channel is the one that had changed. Alternatively, the number of primary communication channels may be more than one and if any of the identified primary communication channels are being changed, the proposal mod will propose an alternative communication channel.

Processing ends as step S290, where formal change mod 390 submits a formal change of contact information to the set of trusted entities relying upon the particular contact information that has changed. Formal change requests are automatically generated when access information and/or templates are provided for submission. Alternatively, a formal change request is provided for use by the user for submission to one of more entities of the set of trusted entities. In some embodiments of the present invention, a detailed summary of change requests is provided to the user with an indication as to which entities were automatically notified and which ones require further attention by the user.

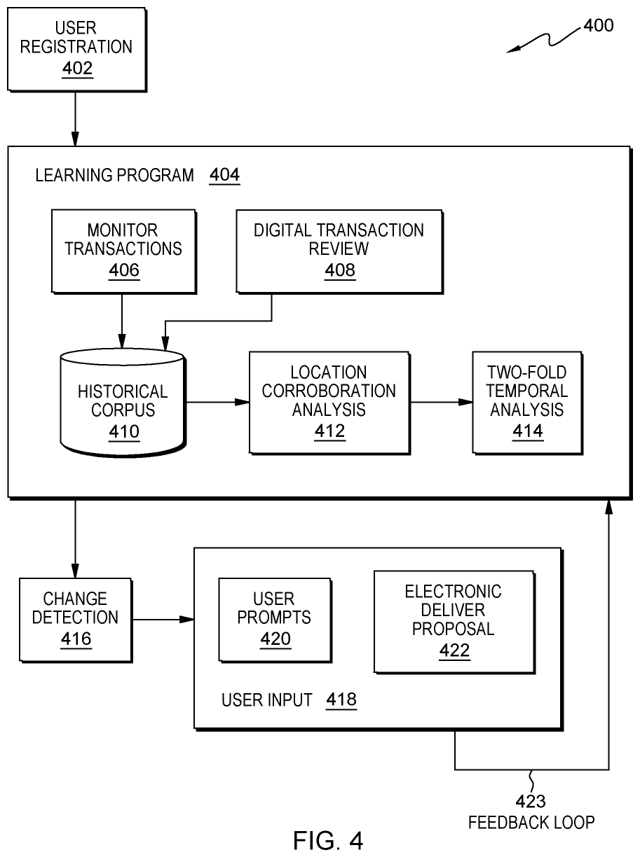

Further embodiments of the present invention are discussed in the paragraphs that follow and later with FIG. 4.

Some embodiments of the present invention are directed to determining how contact information can be kept current so as to avoid the penalties and inconvenience of incorrect or incomplete contact information. Some embodiments of the present invention incorporate location-based services to identify when a specified person no longer resides at the physical address maintained by a trusted vendor or service provider. According to some embodiments, when a physical address stored by a trusted vendor or service provider is flagged as incorrect, the user is asked to confirm that the physical address is no longer valid and/or to provide accurate address information.

Some embodiments of the present invention incorporate location-based services to identify whether a user resides at an address of record. A process for performing location-based address changes may include: (i) generating a personal corpus of user devices and locations; (ii) identifying specific location trends for a user; and (iii) in response to determining the user has changed addresses based on the identified location trends, prompting the user to confirm the address change.

Some embodiments of the present invention do more than validate user address information associated with an account of the user by monitoring locations of the user and time information associated with each transaction of a plurality of transactions to determine that the recorded user address information has changed. Some embodiments of the present invention do more than prompt a user to update a current primary address in response to determining the user has changed addresses and updating the current primary address on file with a new primary address.

Some embodiments of the present invention are directed to collaborating location information collected from various sources including: (i) IoT devices; (ii) devices logged in by the user; and/or (iii) transaction data.

Some embodiments of the present invention are directed to improving data security and compliance by maintaining current contact information for data users and contributors. Statistical models for maintaining current information may also support user authentication or verification with regard to secure data use and distribution.

Some embodiments of the present invention are directed to prompting a user to confirm and identified address as a new address for use with vendors and service providers. Further, when an address is confirmed, embodiments of the present invention may automatically update a local postal service or mail carrier according to a pre-defined communication channel, whether by automated submission of change via the internet, voice message, and/or text message. It should be noted that changing addresses with certain entities may require user authentication and that fully automated changes will be executed whenever technology permits.

Some embodiments of the present invention do more than compute a location-based trustworthiness score for a user based on determining at least the time-location data from one or more transactions involving the user, comparing the location data with the location-based attribute to determine a level of location compliance, and enabling a verification module to verify reliability or legitimacy of the user profile information provided by a corresponding user to accurately update the trustworthiness rating based on initial trustworthiness rating and the trustworthiness factor.

According to some embodiments of the present invention the user-specific corpus includes information concerning where and when the user spends time including when the user device indicates a current location as being at a place of residence. Residence may be indicated by regular locations being identified over a specified period of time such as 6 months. Other data that may be collected for the user-specific corpus may include: (i) credit transaction data including a location where the purchases take place; and (ii) digital transactions including IP address and time/day of purchase.

According to some embodiments of the present invention, location information collected for processing is anonymized for obscuring the user identity from back-end users, who would only see a difference or change in location. Further, some embodiments include local storage of location information to reduce the likelihood of online access.

Some embodiments of the present invention are directed to a cross-verification process to confirm contact information changes. The cross-verification process provides for potential manual override of information changes and/or confirmation of changes by an authorized third-party such as a government office or trusted vendor or service provider.

Some embodiments of the present invention are directed to managing temporary changes in contact information by updating information for a specified period of time after which the contact information reverts back to the previously listed information. Further, during a confirmed temporary change in contact information, vendors and/or service providers may be contacted with an alternative communication channel during the period of temporary change.

FIG. 4 shows system 400 depicting software for training a statistical model, determining a change in residential address should be made, and taking actions including a user feedback loop for refining the model according to an embodiment of the present invention. This system and example process steps will now be discussed, over the course of the following paragraphs, with extensive reference to FIG. 4, for the system blocks. While the discussion related to FIG. 4 introduces residential address changes, other contact information changes may also be detected by similar systems.

Processing begins with user registration 402, where users agree to certain specific use of data and data collection methods. Registration includes providing computing device information for accessing location services as well as certain applications such as calendaring, social media, and transactional data. Users may also input a current residential address and any other contact information that may be of interest.

Processing proceeds with operations performed by learning program 404 including: monitor transactions module 406, digital transactions module 408, historical corpus 410, location corroboration analysis module 412, and two-fold temporal analysis module 414. The learning program operates to collect data and train a statistical model to monitor user activity for predicting residential address changes.

Processing proceeds with user transactions being monitored (406) for transaction information including location data for transactions. In this example, the learning program identifies geography-based patterns in transaction data. Digital transactions are also examined (408) for location data indicating locations of interest as well as locations in which digital transactions are initiated. Patterns related to digital transactions may provide insight as to a home location or primary residence. Training on historic corpus data (410) builds a robust statistical model for predicting primary or preferred locations as they change over time.

Processing proceeds with analysis of identified locations as reported by various registered devices including internet of things (IoT) devices. Data that may be collected includes: (i) IP addresses that reflects the locations that a user logs onto a specific application; (ii) location information of registered smart phones and/or smart watches; (iii) transaction data for various authorized applications for analyzing in-app purchases. The collected data is analyzed for corroboration on locations where the registered user performs various tasks and/or transactions.

Processing proceeds with a two-fold temporal analysis (414) of the collected data in historical corpus 410 and corroborated location data from location analysis module 412. The two-fold analysis considered time of day patterns as well as weekly, monthly, and annual timeline patterns. Essentially, some daily patterns may appear to trigger a change in residence or other contact information.

Processing proceeds with monitoring collected transaction information to detect a potential change of residential address (416). Upon detecting a potential address change, process proceeds to seeking user input (418) by prompting the registered user (420) to confirm a residential address change and recommending electronic delivery of certain information (422) during the change of address process. During registration a user may indicated certain entities with whom the user wishes to maintain contact with a current residential address and/or with whom the user may wish to transition to electronic messaging during transitional periods. Alternatively, electronic delivery proposal module 422 identifies recent transactions and corresponding entities as candidates for temporary electronic delivery during residential address changes.

User responses to the prompts and proposals (420, 422) are returned to learning program 404 via feedback loop 423 for refining the statistical model to better predict address changes.

When a user living in Orlando moves to Atlanta, many vendors and service providers may need to update the address information on file. Some embodiments of the present invention notify the user that a physical address on record for one or more entities may no longer be accurate. Further, the user may be prompted to update the address information. According to some embodiments of the present invention, the user may simply respond by inputting a password or touch ID to make the necessary address changes for the various entities who maintain address information records.

Some embodiments of the present invention operate from the perspective of a service provider in that when a user is identified as having potentially changed addresses a notification is presented to the user seeking confirmation of the address change. This may occur by email, text, or by a prompt the next time the user logs onto a specified website.

Some embodiments of the present invention are directed to a method for assuring coupons and/or other promotional materials reach users who have expressed interest in receiving them.

Some embodiments of the present invention are directed to keeping track of a user location in order to help accurately maintain and/or update user profile information.

Some embodiments of the present invention are directed to using geolocation to confirm contact and residence information of a user.

Some embodiments of the present invention are directed to identifying a change in residential address and prompting the user to change their residential address on various platforms. Further, some embodiments of the present invention automatically update the residential address of a user of various authorized platforms.

Some embodiments of the present invention are directed to offering various alternatives for a user to receive certain contact change information including text, email, SMS, and phone calls.

Some embodiments of the present invention may include one, or more, of the following features, characteristics and/or advantages: (i) can help automate and accelerate compliance with regulations such as the GDPR, CCPA, HIPAA; (ii) supports address changes for IoT-based purchasing plans; and/or (iii) assures correct address information as the current address thereby avoiding denial of services, mis-shipped goods with incorrect addresses, and faded notifications.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

What is claimed is:

1. A computer-implemented method comprising:
identifying a set of contact information recorded at least in part by a set of trusted entities;
monitoring, by a machine learning algorithm, user activity for location-based transaction data;
detecting a change in a first piece of contact information of the set of contact information;
responsive to detecting the change, identifying a sub-set of trusted entities using the first piece of contact information; and
submitting a change request to the sub-set of trusted entities;
wherein:
at least the monitoring, detecting, and identifying steps are performed by computer software running on computer hardware.

2. The computer-implemented method of claim 1, further comprising:
responsive to identifying the sub-set of trusted entities, proposing to the sub-set of trusted entities an alternative communication channel to the first piece of contact information.

3. The computer-implemented method of claim 2, wherein the sub-set of trusted entities use the first piece of contact information as a primary communication channel.

4. The computer-implemented method of claim 1, further comprising:
creating a training corpus by collecting a set of location-based transaction data while monitoring user activity and obtaining user input including the set of contact information; and
training a statistical model with the training corpus for detecting the change in the first piece of contact information.

5. The computer-implemented method of claim 4; further comprising:
responsive to detecting the change, contacting the user for confirmation of the change;
receiving a user confirmation response;
providing the user confirmation response to the training corpus in a feedback loop for refinement of the statistical model.

6. The computer-implemented method of claim 1, wherein:
monitoring user activity includes collecting device-specific transaction information; and
detecting the change in the first piece of contact information includes:
performing location corroboration among a plurality of user devices taking into account a time of day associated with the change and a month in which the change is detected.

7. The computer-implemented method of claim 1, wherein:
the first piece of contact information is a residential address of the user; and
an entity of the sub-set of trusted entities is a magazine publisher.

8. A computer program product comprising a computer-readable storage medium having a set of instructions stored therein which, when executed by a processor, causes the processor to perform a method comprising:
identifying a set of contact information recorded at least in part by a set of trusted entities;
monitoring, by a machine learning algorithm, user activity for location-based transaction data;
detecting a change in a first piece of contact information of the set of contact information;
responsive to detecting the change, identifying a sub-set of trusted entities using the first piece of contact information; and
submitting a change request to the sub-set of trusted entities.

9. The computer program product of claim 8, further causing the processor to perform a method comprising:
responsive to identifying the sub-set of trusted entities, proposing to the sub-set of trusted entities an alternative communication channel to the first piece of contact information.

10. The computer program product of claim 9, wherein the sub-set of trusted entities use the first piece of contact information as a primary communication channel.

11. The computer program product of claim 8, further causing the processor to perform a method comprising:
creating a training corpus by collecting a set of location-based transaction data while monitoring user activity and obtaining user input including the set of contact information; and
training a statistical model with the training corpus for detecting the change in the first piece of contact information.

12. The computer program product of claim 11; further comprising:
responsive to detecting the change, contacting the user for confirmation of the change;
receiving a user confirmation response;
providing the user confirmation response to the training corpus in a feedback loop for refinement of the statistical model.

13. The computer program product of claim 8, wherein:
monitoring user activity includes collecting device-specific transaction information; and
detecting the change in the first piece of contact information includes:
performing location corroboration among a plurality of user devices taking into account a time of day associated with the change and a month in which the change is detected.

14. The computer-implemented method of claim 8, wherein:
the first piece of contact information is a residential address of the user; and
an entity of the sub-set of trusted entities is a magazine publisher.

15. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
identifying a set of contact information recorded at least in part by a set of trusted entities;
monitoring, by a machine learning algorithm, user activity for location-based transaction data;
detecting a change in a first piece of contact information of the set of contact information;
responsive to detecting the change, identifying a sub-set of trusted entities using the first piece of contact information; and
submitting a change request to the sub-set of trusted entities.

16. The computer system of claim 15, further causing the processor to perform a method comprising:
responsive to identifying the sub-set of trusted entities, proposing to the sub-set of trusted entities an alternative communication channel to the first piece of contact information.

17. The computer system of claim 16, wherein the sub-set of trusted entities use the first piece of contact information as a primary communication channel.

18. The computer system of claim 15, further causing the processor to perform a method comprising:
creating a training corpus by collecting a set of location-based transaction data while monitoring user activity and obtaining user input including the set of contact information; and
training a statistical model with the training corpus for detecting the change in the first piece of contact information.

19. The computer system of claim 18; further comprising:
responsive to detecting the change, contacting the user for confirmation of the change;
receiving a user confirmation response;
providing the user confirmation response to the training corpus in a feedback loop for refinement of the statistical model.

20. The computer system of claim 15, wherein:
monitoring user activity includes collecting device-specific transaction information; and
detecting the change in the first piece of contact information includes:
performing location corroboration among a plurality of user devices taking into account a time of day associated with the change and a month in which the change is detected.
